(19) United States
(12) Patent Application Publication
(10) Pub. No.: US 2016/0065126 A1
(43) Pub. Date: Mar. 3, 2016

(54) METHOD FOR CONTROLLING A COOLING DEVICE FOR INCREASING THE LIFETIME OF COMPONENTS GENERATING WASTE HEAT, AND COOLING DEVICE

(71) Applicant: SMA Solar Technology AG, Niestetal (DE)

(72) Inventors: Christian Jochen Felgemacher, Kassel (DE); Christian Noeding, Knuellwald-Remsfeld (DE); Peter Zacharias, Kassel (DE); Samuel Vasconcelos Araujo, Kassel (DE)

(21) Appl. No.: 14/838,577

(22) Filed: Aug. 28, 2015

(30) Foreign Application Priority Data
Aug. 29, 2014 (DE) 102014112458.8

(51) Int. Cl. H02S 40/44; H02S 40/42

(52) U.S. Cl. CPC H02S 40/44; H02S 40/425

(57) ABSTRACT

For controlling a cooling device with limited power during the cooling of an apparatus which generates waste heat to a variable extent over each of a plurality of operating periods, a maximum temperature is defined individually for different operating periods from among the operating periods such that a maximum power of the cooling device that occurs upon the control of the power of the cooling device, in order to limit a detected actual temperature (actT) of the apparatus to the defined maximum temperature, during the respective operating period complies with a predefined power of the cooling device.

### REFERENCE TO RELATED APPLICATION

This application claims priority to German Application number 10 2014 112 458.8, filed on Aug. 29, 2014, and incorporated herein by reference in its entirety.

### FIELD

The disclosure relates to a method for controlling a cooling device for increasing the lifetime of components generating waste heat, and to a cooling device for carrying out such a method. More precisely, the disclosure relates to a method for controlling a cooling device of limited cooling power or power consumption during the cooling of an apparatus which generates waste heat to a variable extent over each of a plurality of operating periods. Specifically, the apparatus can be an apparatus comprising a power component of a photovoltaic installation.

### BACKGROUND

In one known method for controlling a cooling device during the cooling of an apparatus, the cooling power of the cooling device is controlled depending on the actual temperature of the apparatus, wherein the cooling power increases with the actual temperature. Although this results in a damping effect on the temperature swing of the apparatus, considerable temperature fluctuations and thus thermal loadings of the components of the apparatus nevertheless occur, which have a considerable adverse effect on the lifetime thereof.

In a further known method for controlling a cooling device during the cooling of an apparatus, a maximum temperature of the apparatus is defined, and the actual temperature of the apparatus is detected. The power of the cooling device is then controlled such that the actual temperature does not exceed the maximum temperature. In order that the lifetime of components of the apparatus is not adversely affected by temperature fluctuations, the maximum temperature in this case is used as a setpoint temperature to which the actual temperature is matched as long as this is made possible by the waste heat generated by the apparatus, i.e. the actual temperature is regulated to the maximum temperature. The maximum temperature of the apparatus is defined such that it can be complied with by the cooling device under all customary circumstances.

U.S. Pat. No. 8,624,411 discloses a power generating system comprising a predictive controller in order to reduce influences of factors that vary with the weather. For this purpose, the intention is to co-ordinate a control strategy for the operation of a component or a subsystem of the power generating system anticipatorily, i.e. in advance, on the basis of predicted power generating conditions for an array of power generators over the time horizon. The components or subsystems operated in this way include a cooling device of an inverter for the power of the power generators, wherein the cooling of the inverter is adapted to a lower waste heat generated. The predictive control is intended to achieve a lengthening of the lifetime of components of the power generating system.

EP 2 200 079 A1 discloses a method and an apparatus for operating a power semiconductor component, in particular an IGBT. A cooling system is assigned to the IGBT, and heat generated by the IGBT can be dissipated by said cooling system. A quantity of cooling medium that is conveyed by the cooling system is adjustable. Means are provided for controlling the quantity of cooling medium conveyed through the cooling system in such a way that the amount of heat dissipated from the IGBT is precisely enough that the temperature of the IGBT remains substantially constant. In this case, it is said to be advantageous if an expected future temperature of the power semiconductor component is determined depending on an expected future current profile via the power semiconductor component. It is thus possible to determine in advance what expected temperature changes will occur at the power semiconductor component. Depending on these expected temperature changes, the quantity of cooling medium conveyed through the cooling system can then be set in such a way that the temperature changes precisely do not occur, that is to say that the temperature of the power semiconductor component remains substantially constant.

WO 2010/041175 A1 discloses a power semiconductor apparatus with an adaptive cooling device. The cooling device comprises an actively cooled heat sink and a controller, which sets the cooling power of the heat sink depending on the temperature of a part of the power semiconductor apparatus which carries a power current. In this way, the thermal loading of the power semiconductor device is reduced and the lifetime thereof is increased.

US 2008/0188994 A1 discloses a method for controlling the speed of a cooling fan provided for cooling an integrated circuit. The method comprises detecting a temperature of the integrated circuit and, if the temperature is not within a predefined range, controlling the speed of the fan on the basis of the temperature.

WO 2007/051464 A1 discloses a method for lengthening the lifetime of a component that generates waste heat in a wind power installation. In accordance with this method, the temperature of the component is adjusted to a setpoint value that is decreased down to a lower limit value in slow steps, which are preferably in the range of a number of hours. If the quantity of waste heat generated then becomes greater than can be dissipated by a cooling device, such that the temperature of the component rises, the peak temperature attained by the component is detected. The peak temperature is used as a new setpoint value for the temperature of the component, which is then decreased again in steps. By this means, the number of temperature cycles of the component is intended to be reduced and the temperature of the component is intended to be kept as low as possible, in principle.

### SUMMARY

The problem addressed by the disclosure is that of demonstrating a method for controlling a cooling device with limited power during the cooling of an apparatus which generates waste heat to a variable extent over each of a plurality of operating periods, with which method the lifetime of components of the apparatus that generate waste heat is increased and, at the same time, the power consumed by the cooling device is limited. Furthermore, the intention is to demonstrate a cooling device suitable for implementing such a method.

In a method according to one embodiment of the disclosure for controlling a cooling device with limited power during the cooling of an apparatus which generates waste heat to a variable extent over each of a plurality of operating periods, an actual temperature of the apparatus is detected, and the power of the cooling device is controlled in order to limit the actual temperature to a maximum temperature. In this case, the maximum temperature of the apparatus is defined individually for each of the operating periods such that a maximum power of the cooling device that occurs upon the control of the power of the cooling device during the respective operating period complies with a predefined power of the cooling device.

The fact that in the method according to one embodiment of the disclosure the maximum temperature is defined such that a maximum power of the cooling device that occurs upon the control of the power of the cooling device during the respective operating period complies with the predefined power of the cooling device, does not just mean that the predefined power of the cooling device is not exceeded, which could easily be achieved by the maximum temperature being set very high. Rather, in the method according to the disclosure, the predefined power of the cooling device is also actually attained and the cooling device is thus used to keep the maximum temperature low in favor of a small temperature swing and a corresponding small thermal loading of the apparatus generating the waste heat.

In this case, the predefined power of the cooling device can be predefined as an individual value or as a power interval, such that the maximum power of the cooling device that occurs during the respective operating period complies with the predefined power of the cooling device if it falls within the predefined power interval. Specifically, the individual value or the power interval is expediently an individual value or a power interval of the power consumption of the cooling device because the cooling power of the cooling device, depending on the operating conditions thereof, varies too much to be suitable as a superordinate scale.

In the method according to one embodiment of the disclosure, the maximum temperature need not be defined individually for each of the operating periods. In this regard, for all operating periods for which the individual definition of the maximum temperature would lead to maximum temperatures below a temperature limit value, the temperature limit value can instead be used as a maximum temperature in order to save power of the cooling device because the temperature limit value already keeps the temperature swing and thus the thermal loading of the apparatus that generates waste heat within narrow limits.

The maximum temperature need not be defined before the respective operating period, but rather can also be defined in the course of the respective operating period. In this case, it is possible to proceed from a provisional value of the maximum temperature, which provisional value is increased during the operating period whenever it emerges that the provisional value is set too low. Criteria for a provisional value set too low may be that the actual temperature of the apparatus exceeds the previous provisional value despite a predefined maximum power of the cooling device and/or that the power of the cooling device exceeds a predefined upper power limit value for a predefined period upon compliance with the previous provisional value. In this case, the predefined maximum power of the cooling device can be e.g. the upper limit of a power interval which defines the predefined power of the cooling device. However, this can also involve the maximum power possible at all for the cooling device. The upper power limit value for the power of the cooling device can also be, in principle, the upper limit of a power interval which defines the predefined power of the cooling device. The predefined period should be chosen such that the provisional value of the maximum temperature can follow its necessary rise on account of waste heat additionally generated by the apparatus.

The new provisional value of the maximum temperature can be defined as the actual temperature of the apparatus which exceeds the previous provisional value at the predefined maximum power of the cooling device, or the previous provisional value increased by a predefined temperature increment. In this case, the temperature increment should be chosen to be large enough to be able to follow a necessary increase in the provisional value.

If defining the maximum temperature is a procedure that operates with a provisional value which is adapted upwards as required, the current actual temperature or a value dependent on the current actual temperature or a value that is identical for each operating period can be used as a start value for the provisional value at the beginning of the respective operating period. In this way, the provisional value of the maximum temperature and thus also the highest provisional value, i.e. the actual maximum temperature, is kept as low as possible during the respective operating period. This also means, however, that a relatively large amount of power is consumed by the cooling device until the provisional value has adapted to the actual value of the maximum temperature in the respective operating period.

In order to minimize the power of the cooling device, the provisional value of the maximum temperature has to be brought as close as possible to the actual maximum temperature from the outset. For this purpose, it can be defined as an expected value at the beginning of the respective operating period. The expected value can be dependent on the temporal situation of the operating period and/or weather forecasts for the operating period and/or an operating plan of the apparatus for the operating period. In the case of a photovoltaic installation, the temporal situation of the operating period of a day primarily includes the season. Weather forecasts for the operating period affect the maximum temperature not only via the waste heat that arises, but also via the waste heat that can be dissipated by the cooling device. An operating plan of the apparatus is of importance particularly if the operation of an apparatus that generates waste heat can be planned overall or at any rate within limits of external influences.

On the basis of the data discussed, it is possible to make a forecast for the profile of the generated waste heat and of the available cooling power during the operating period and to deduce therefrom the maximum temperature to be expected. In this case, in order to keep down the use of cooling power in the cooling device, the expected value can be chosen at an upper error limit of the forecast maximum temperature. Conversely, it can also be defined at a lower error limit of the forecast maximum temperature in order that the maximum temperature of the apparatus that generates waste heat is kept as low as possible during the respective operating period. All intermediate values are possible in addition.

In addition, in the method according to one embodiment of the disclosure, the power of the cooling device can be controlled such that a rise in the actual temperature until attaining the maximum temperature and/or the provisional value of the maximum temperature is limited to a maximum rate. In any case, when controlling the cooling device, care should be taken to avoid rapid temperature changes in the apparatus that generates waste heat, and thermal loadings resulting therefrom. Components having thermal inertia cannot follow a rapid temperature change. If such components having thermal inertia are fixedly connected to components having less thermal inertia in the apparatus, this results in high thermally dictated mechanical stresses.

Upon the control of the power of the cooling device in the context of the method according to one embodiment of the disclosure, the power of the cooling device can be set in a manner dependent, in particular linearly dependent, on the actual temperature of the apparatus such that the power of the cooling device attains a predefined power of the cooling device if the actual temperature attains the maximum temperature. Specifically, in one embodiment the cooling power KL can be set in accordance with

KL=KLmin+(KLpre−KLmin) (ActT−Tmin)/(Tmax−Tmin)

wherein KLmin is a minimum cooling power at a minimum temperature Tmin, KLpre is the predefined cooling power to be complied with, and Tmax is the maximum temperature. In this case, KLmin can be zero. Tmin can be the temperature in the environment of the apparatus that serves as a heat sink for the cooling device. As an alternative thereto, Tmin can correspond to a temperature of a heat sink or of a component of the apparatus which is determined immediately before or shortly after the start of the normal operation of the apparatus within the operating period. Since, with the apparatus deactivated, the temperature of the components of the apparatus approaches the ambient temperature over the course of time, the temperature of the environment of the apparatus and the temperature of components of the apparatus are comparable, if they are recorded immediately before or shortly after the start of the operation of the apparatus. With this specification for the control of the cooling power, the profile of the actual temperature of the apparatus is damped compared with a profile without control of the cooling power, and the actual temperature of the apparatus, not only within an operating period as a whole but also within smaller time intervals within the operating period—typically at every time within the operating period—is a variable that results from the waste heat of the components generating waste heat, the present power of the cooling system and the ambient conditions.

However, the control of the power of the cooling device in the context of the method according to one embodiment of the disclosure can also serve for adjusting the actual temperature of the apparatus to match the maximum temperature as a setpoint value in order to keep the apparatus at this one temperature for as long as possible. This embodiment of the method according to one embodiment of the disclosure is also referred to as a regulation variant hereinafter.

In the case of the regulation variant, the predefined power of the cooling device which is complied with in the method according to one embodiment of the disclosure can, for its part, be dependent on the maximum temperature. That is to say, for example, that a lower predefined power of the cooling device is taken into account with a lower maximum temperature than with a higher maximum temperature, in order to save power of the cooling device. In this case, the predefined power of the cooling device expediently rises monotonically with the maximum temperature as a function of the maximum temperature.

Furthermore, in the case of the regulation variant of the method according to one embodiment of the disclosure, if the actual temperature of the apparatus falls below the maximum temperature at a predefined minimum power of the cooling device and/or if the power of the cooling device falls below a predefined lower power limit value for a predefined further period upon compliance with the maximum temperature, a changeover can be made to the controlling of the power of the cooling device in which the actual temperature is adjusted to match a target temperature below the maximum temperature as setpoint temperature. In the case of a photovoltaic installation, the waste heat generated decreases at the end of the day very generally to such an extent that the maximum temperature is no longer maintained even in the case of a cooling power of the cooling device of zero. If this is foreseeable, it is expedient not to attempt any longer to comply with the maximum temperature, but rather to return the temperature of the apparatus to its night temperature slowly, i.e. with a limited rate of temperature change. The target temperature defined here, which replaces the maximum temperature as setpoint temperature typically for the rest of the operating period, is used for this purpose. However, the changeover of the setpoint temperature from the maximum temperature to the target temperature can also take place at a specific point in time during the respective operating period, about which it is known that the maximum temperature will then no longer be attained.

Analogously to increasing a provisional value of the maximum temperature, the target temperature can be reduced proceeding from the maximum temperature if the actual temperature of the apparatus falls below the previous target temperature at the predefined minimum power of the cooling device and/or if the power of the cooling device falls below the predefined lower power limit value for the predefined further period upon compliance with the previous target temperature. The new target temperature can then be defined as the actual temperature of the apparatus which falls below the previous target temperature at the predefined minimum power of the cooling device, or the previous target temperature decreased by a predefined temperature increment.

A fall in the actual temperature towards the end of the respective operating period is also expediently limited to a maximum limit by the control of the power of the cooling device in one embodiment.

As an alternative to the regulation to a target temperature, if it is foreseeable that the actual temperature of the apparatus will no longer exceed the maximum temperature at a predefined maximum cooling power for the respective operating period, it is possible to effect a changeover to a straightforward control of the cooling system taking account of the maximum temperature. For a cloud-free day and with a PV installation as apparatus, this is typically the case in the second half of the day. In this case, there is no longer any attempt made to approximate the actual temperature to the maximum temperature, rather the power of the cooling device is merely controlled in a manner dependent on the maximum temperature and the established actual temperature. In this case, the maximum temperature is constant in the further course of the respective operating period—e.g. the respective day. Specifically, the power of the cooling device can be controlled in accordance with the equation reproduced above in a manner dependent on the difference between the actual temperature actT and the temperature Tmin taking account of the maximum temperature Tmax obtained last. This results in a linear decrease in the power of the cooling device with the actual temperature actT until the actual temperature actT reaches the temperature Tmin at which cooling of the apparatus no longer appears to be expedient and which thus corresponds to a power of the cooling device of 0. In this case, the temperature Tmin can be chosen such that it corresponds to the actual temperature immediately before or shortly after the start of the normal operation of the apparatus in the current operating period. Alternatively, the temperature Tmin can correspond to the actual temperature within a period at the end of the preceding operating period. However, it can also be stored in tables—e.g. depending on the season—and taken from them.

A cooling device according to one embodiment of the disclosure for cooling an apparatus which generates power loss to a variable extent over each of a plurality of operating periods comprises a temperature sensor for detecting the actual temperature of the apparatus. The cooling device further comprises a controller for controlling the power of the cooling device in order to limit the actual temperature to a defined maximum temperature. The controller defines the maximum temperature individually for different operating periods from among the operating periods such that a maximum power of the cooling device that occurs upon the control of the power of the cooling device during the respective operating period complies with a predefined power of the cooling device. To explain these features and further features of various embodiments of the cooling device according to the disclosure, reference is made to the above explanations concerning the method according to the disclosure.

In order to be able to define an expected value for the maximum temperature, the controller can have an interface for receiving data concerning the temporal situation of the operating period and/or concerning weather forecasts for the operating period and/or concerning the operating plan of the apparatus for the operating period.

Advantageous developments of the disclosure are evident from the patent claims, the description and the drawings. The advantages of features and of combinations of a plurality of features, as mentioned in the description, are merely by way of example and can take effect alternatively or cumulatively, without the advantages necessarily having to be afforded by embodiments according to the disclosure. Without hereby altering the subject matter of the appended patent claims, the following holds true with regard to the disclosure content of the original application documents and of the patent: further features can be gathered from the drawings—in particular from the illustrated relative arrangement and operative connection of a plurality of components. The combination of features of different embodiments of the disclosure or of features of different patent claims is likewise possible in a manner departing from the dependency references chosen for the patent claims and is hereby suggested. This also concerns those features which are illustrated in separate drawings or are mentioned in the description thereof. These features can also be combined with features of different patent claims. Likewise, features presented in the patent claims can be omitted for further embodiments of the disclosure.

The features mentioned in the patent claims and the description should be understood, with regard to their number, such that exactly this number or a number greater than the number mentioned is present, without the need for an explicit use of the adverb “at least”. Therefore, if mention is made of one element, for example, this should—generally—be understood to mean that exactly one element, two elements or more elements are present. These features can be supplemented by other features or be the sole features of which the respective product consists.

The reference signs contained in the patent claims do not restrict the scope of the subjects protected by the patent claims. They merely serve the purpose of making the patent claims more easily understood.

### BRIEF DESCRIPTION OF THE DRAWINGS

The disclosure is described and explained in greater detail below on the basis of exemplary embodiments with reference to the accompanying drawings.

FIG. 1 schematically depicts a photovoltaic installation comprising a cooling device for an inverter as apparatus that generates waste heat.

FIG. 2 is a flow chart concerning one embodiment of the method according to the disclosure when controlling the cooling device in accordance with FIG. 1.

FIG. 3 is a more detailed flow chart concerning part of the flow chart in accordance with FIG. 2.

FIG. 4 is a flow chart concerning another embodiment of the method according to the disclosure when controlling the cooling device in accordance with FIG. 1.

FIG. 5 is a flow chart concerning one possible additional routine in a method according to the disclosure when controlling the cooling device in accordance with FIG. 1.

FIG. 6 is a plot of the temperature of the inverter in accordance with FIG. 1 over a day with application of the method in accordance with FIG. 2.

FIG. 7 is a plot of the temperature of the inverter in accordance with FIG. 1 over a day with application of the method in accordance with FIG. 4 with the additional routine in accordance with FIGS. 5; and

FIG. 8 is a plot of the temperature of the inverter on a day with low power of the photovoltaic installation in accordance with FIG. 1 firstly with application of the method in accordance with FIG. 2 and secondly with application of the method in accordance with FIGS. 4 and 5.

### DETAILED DESCRIPTION

The power of a photovoltaic installation and thus also the waste heat generated by the power components of the photovoltaic installation depend on the intensity of the sunlight incident upon photovoltaic modules of the photovoltaic installation. Therefore, they vary greatly over the course of a day as individual operating period of the photovoltaic installation. In addition, weather influences, in particular in the form of cloud, precipitation and temperature, affect the power and waste heat of a photovoltaic installation.

The cooling power of a cooling device is also weather-dependent since the ambient temperature and also the air humidity in the environment and sunlight incident on the cooling device greatly influence the quantity of heat that can be dissipated with the aid of the cooling device for the same power consumption of the cooling device.

When the power of the cooling device is mentioned hereinafter, this refers to the power consumption thereof and/or its resulting cooling power. Often a cooling device will be controllable only directly with regard to its power consumption and not with regard to its cooling power. However, in so far as only the power of the cooling device is mentioned here, no distinction is drawn between its power consumption and its cooling power.

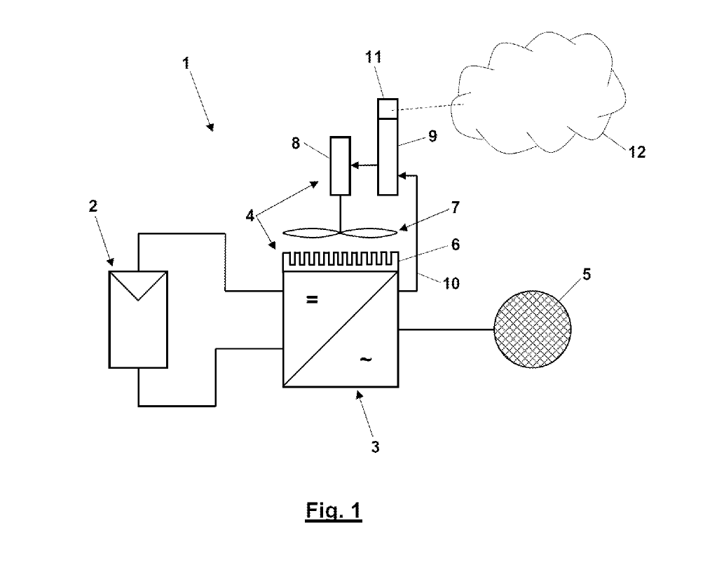

The photovoltaic installation 1 depicted schematically in FIG. 1 comprises a photovoltaic generator 2, an inverter 3 and a cooling device 4 for the inverter 3. The inverter 3 feeds electrical power generated by the photovoltaic generator 2 into an AC grid 5. In this case, power components of the inverter 3 generate heat loss, i.e. waste heat, leading to an increase in the actual temperature of the inverter 3. In order to limit this actual temperature of the inverter 3, the cooling device 4 is provided, which is represented here by way of example in the form of a heat sink 6, to which cooling air is applied by a fan 7. In this case, a motor 8 of the fan 7 is driven by a controller 9 of the cooling device 4 in a manner dependent on the actual temperature 10 detected at the inverter 3. Only one cooling device 4 with one motor 8 and one fan 7 driven by the latter is illustrated in the example in accordance with FIG. 1. Accordingly, only the detection of one actual temperature 10 is illustrated, too, which is detected at the heat sink 6 or at a component of the inverter 3 that is localized in the housing, and is fed to the controller 9. However, it is possible to assign a separate cooling device 4 with a heat sink 6, a motor 8 and a fan 7 in each case to a plurality of different components of the inverter 3. In this case, a plurality of actual temperatures 10 are detected simultaneously at the different components of the inverter 3 and are fed to the controller 9. In this case, each motor 8 of each fan 7 is driven in a manner dependent on the actual temperature 10 detected at the respective component. It is likewise possible for an actual temperature 10 in each case to be detected at a plurality of different components of the inverter 3, but for the inverter to have only one cooling device 4 with one motor 8 and one fan 7. In this case, the motor 8 is advantageously driven in one embodiment by the controller 9 in a manner dependent on the respective highest actual temperature from among the detected actual temperatures 10. The controller 9 additionally has an interface 11 in order, e.g. from the Internet 12, to obtain data which it takes into account during the driving of the motor 8 and thus for the power of the cooling device 4.

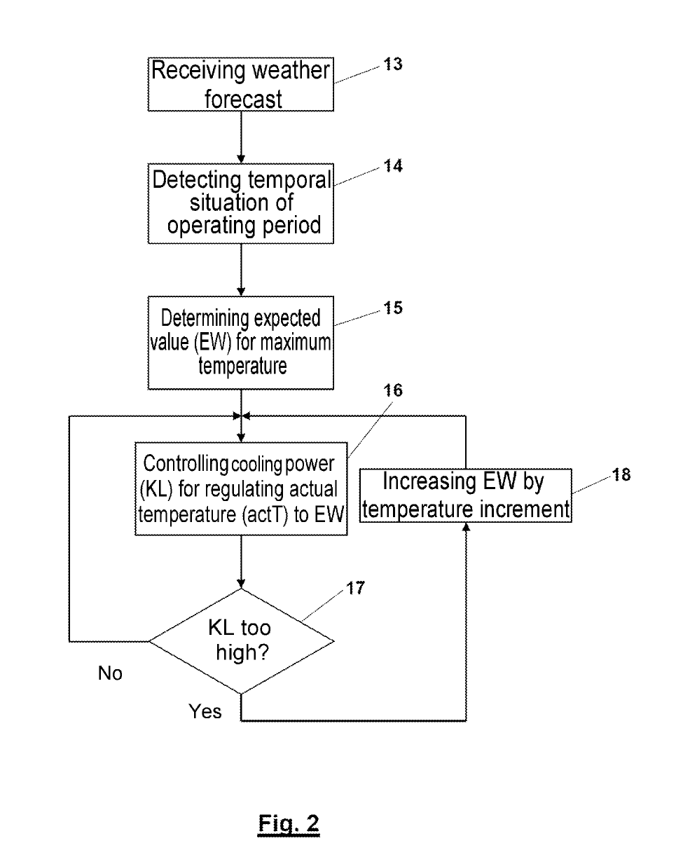

According to the method illustrated in FIG. 2, in an act 13, a weather forecast for the respective day is received by the controller 9 in accordance with FIG. 1. Furthermore, act 14 involves detecting the temporal, in particular the seasonal, situation of the respective day as a relevant operating period of the apparatus cooled by means of the cooling device 4. This seasonal situation results in an expected profile of the solar radiation incident on the photovoltaic generator 2. The profile is combined with the weather forecast, specifically in order to take account firstly of influences of the weather on the insolation and secondly the conditions under which the cooling device operates during the operating period under consideration. On the basis thereof, act 15 involves determining an expected value EW for a maximum temperature in such a way that upon the arrival of the weather forecast a maximum power of the cooling device 4 that occurs upon the matching of the actual temperature 10 (also designated hereinafter as actual temperature actT) of the inverter 3 in accordance with FIG. 1 to the maximum temperature during the current day complies with a predefined power of the cooling device 4. In this case, the compliance of this predefined power of the cooling device 4 with the maximum power of the cooling device 4 that occurs on the respective day means that the maximum power of the cooling device 4 that occurs substantially attains, but does not significantly exceed, the predefined power of the cooling device 4. In this case, the predefined power of the cooling device 4 can be predefined in one embodiment by a power interval of the power consumption of the cooling device. In a subsequent act 16, the power KL of the cooling device 4 is then used for regulating the actual temperature actT to the previously determined expected value EW. If it emerges here in the context of a check 17 that the power KL indeed becomes too high, i.e. exceeds the predefined power of the cooling device 4, in act 18 the expected value EW is increased by a temperature increment of 1 or a plurality of ° C., for example, before the method returns to 16, which takes place immediately in the case where the power KL is not too high. In this regard, the expected value is adapted if necessary to the actual maximum temperature at which the maximum power of the cooling device 4 that occurs on the respective day actually complies with the predefined power of the cooling device 4.

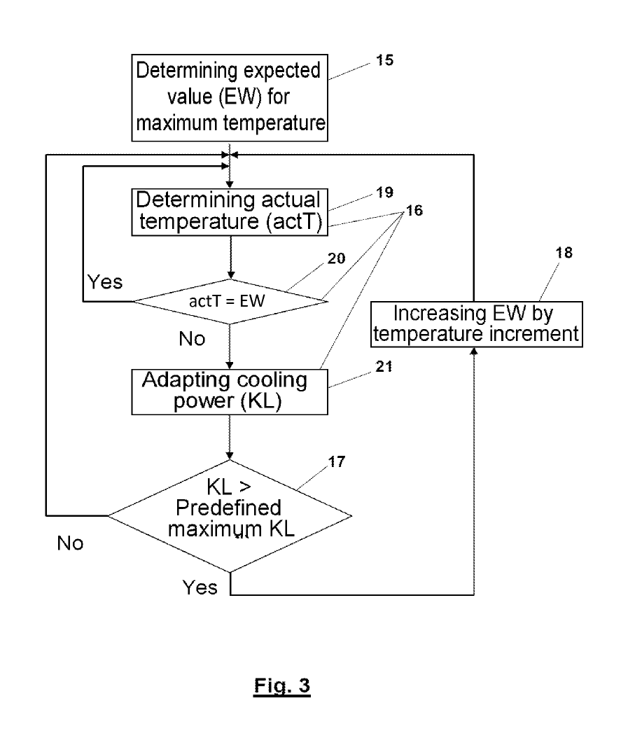

FIG. 3 elucidates how the control of the power KL of the cooling device 4 for regulating the actual temperature actT of the inverter 3 in accordance with FIG. 1 can be manifested in specific detail. A subact 19 of act 16 involves firstly determining the actual temperature actT of the inverter 3. A check 20 then ascertains whether the actual temperature actT is equal to or differs from the expected value EW beyond a certain fault tolerance. If this is the case (Yes at 20), i.e. the actual temperature actT—apart from the certain fault tolerance—is equal to the expected value EW, the method jumps back directly to subact 19. However, if the actual temperature actT deviates from the expected value EW (No at 20), the power KL of the cooling device is adapted at 21. For this purpose, if the actual temperature actT is less than the expected value EW, the power KL of the cooling device is decreased in one embodiment provided that it has not already reached a predefined lower power limit value. By contrast, if the actual temperature actT is greater than the expected value EW, the power KL of the cooling device is increased in one embodiment. A check 17 then checks whether the increased power KL already exceeds a predefined maximum power of the cooling device 4. If so, the expected value EW is increased by the temperature increment at 18.

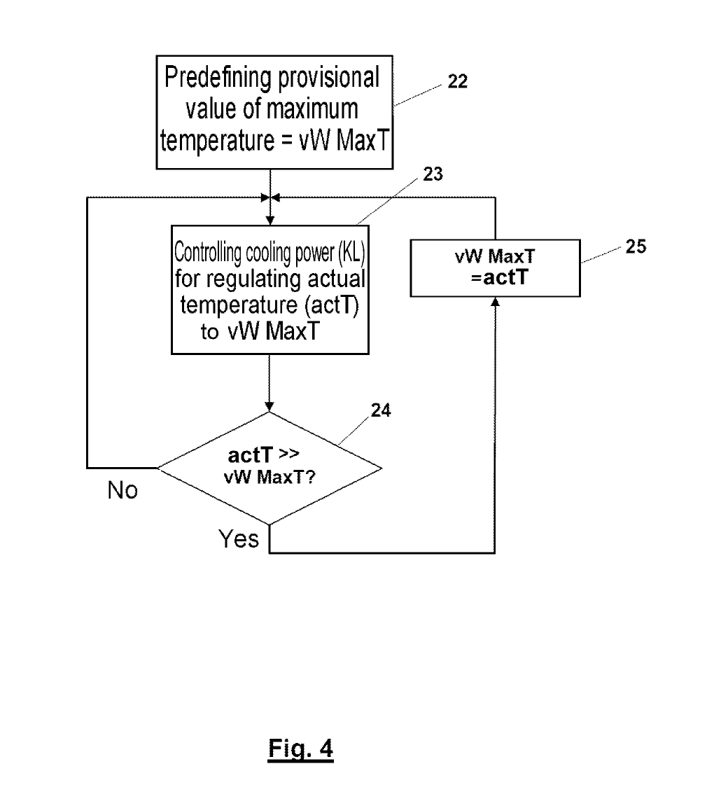

In the case of the embodiment of the method according to the disclosure that is depicted schematically in FIG. 4, a first act 22 does not involve determining an expected value for the maximum temperature on the basis of forecasts and other prior knowledge. Rather, a provisional value vW MaxT for the maximum temperature is defined. This is then followed, at 23, by control—corresponding in principle to step 16 in accordance with FIG. 2—of the power KL of the cooling device 4 for regulating the actual temperature actT of the inverter 3—here to the provisional value vW MaxT of the maximum temperature. If a subsequent check 24 establishes that it is not possible to keep the actual temperature at the currently provisional value vW MaxT of the maximum temperature, rather actT>>vW MaxT, that is to say that the actual temperature actT exceeds the provisional value vW MaxT of the maximum temperature by more than a customary regulation difference, the provisional value vW MaxT is increased at 25 by being defined for example as the actual temperature actT actually attained. Otherwise, the control of the power KL in accordance with act 23 is directly continued. In the method depicted schematically in FIG. 4, with the highest provisional value vW MaxT, the maximum actual temperature that actually occurs in the respective operating period is detected accurately, and this maximum actual temperature becomes the maximum temperature. For this purpose, in the method in accordance with FIG. 4, a relatively large amount of power of the cooling device 4 is used because initially an attempt is made to comply with the actual temperature actT of the inverter 3 beginning with the initial value thereof, i.e. a very low temperature value. By contrast, the expected value determined initially in the method in accordance with FIG. 3, on account of the weather forecasts additionally present, is immediately closer to the maximum temperature sought for the respective operating period than the initial value of the provisional value vW MaxT in accordance with FIG. 4. Consequently, in accordance with FIG. 3, less of an attempt is made to comply with a maximum temperature initially assessed as too low, for which reason the power consumed by the cooling device 4—in comparison with the method in accordance with FIG. 4—tends to be lower in the method in accordance with FIG. 3. The highest expected value EW in accordance with FIG. 3, on account of the incremental increase in the respective preceding value, does not necessarily correspond exactly to the ideal maximum temperature for the respective operating period, but rather is somewhat greater than that. This holds true even if the expected value EW was estimated too highly from the outset.

In an alternative to the method in accordance with FIG. 4, instead of the control of the cooling power KL for regulating the actual temperature actT of the inverter 3 (cf. act 23), (pure) control of the cooling power KL is carried out in the sense of setting the cooling power in order to counteract an increase in the actual temperature actT of the inverter 3. Such control of the cooling power KL can be carried out for example according to the equation specified above. In this case, no attempt is made to adjust the actual temperature actT of the inverter 3 to match a predefined value, rather only a rise or a fall in the actual temperature actT of the inverter 3 is counteracted and thereby inhibited by means of the control of the cooling power KL. In a next act of the alternative method, corresponding to act 24, a check is made to determine whether the actual temperature actT exceeds the provisional value of the maximum temperature vW MaxT beyond a certain fault tolerance. If this is the case, that is to say if actT>>vW MaxT holds true, in a step corresponding to act 25 the provisional value of the maximum temperature vW MaxT is increased, for example to the actual temperature actT currently prevailing. However, increasing the provisional value of the maximum temperature vW MaxT by a predefined temperature increment is also possible here—as described in FIG. 3.

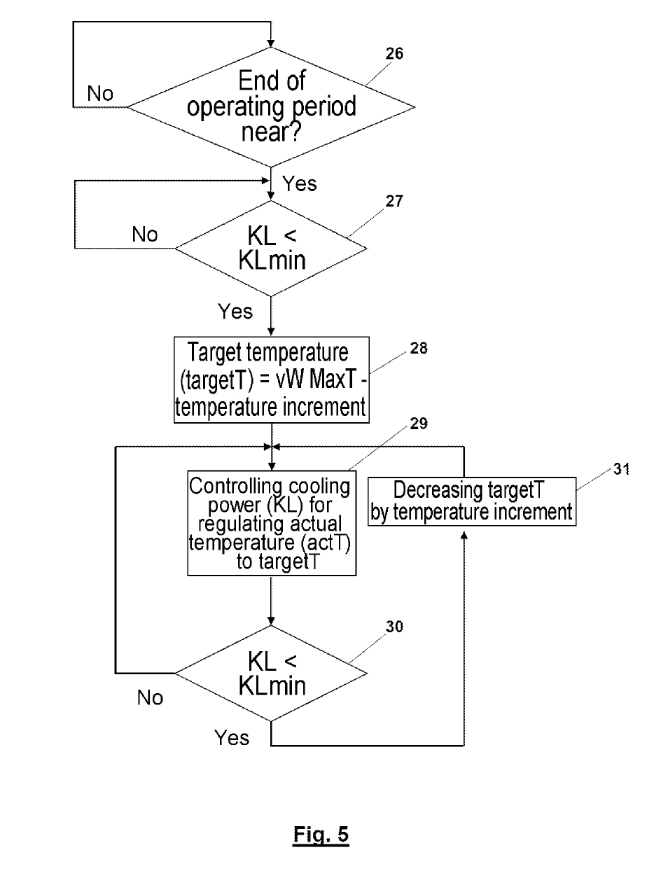

FIG. 5 illustrates a routine with which, at the end of the respective operating period, e.g. the day in the case of the photovoltaic installation in accordance with FIG. 1, the actual temperature actT of the apparatus cooled by the cooling device 4, here of the inverter 3, is decreased early in order to maintain regulation capacity for compensating for temperature fluctuations. This regulation capacity is also provided in the case of the method in accordance with FIG. 4 during the increase in the provisional value vW MaxT of the maximum temperature. By contrast, in the case of the method in accordance with FIG. 2, until the expected value EW of the maximum temperature is reached there may be temperature fluctuations of the inverter which are not compensated for by the cooling device. In the routine in accordance with FIG. 5, a check 26 involves ascertaining whether the end of the operating period is near or at least the typical partial period in which the maximum temperature is reached has passed. If a check 27 additionally ascertains that the cooling power KL—in particular beyond a certain time duration—has fallen below a predefined lower power limit value KLmin, a target temperature TargetT corresponding to the current value of vW MaxT minus a temperature increment is set at 28. At 29, the actual temperature actT is then regulated to said target temperature TargetT by the control of the power KL of the cooling device 4. Upon each occasion of the power limit value KLmin being undershot in this case, which is checked at 30, the target temperature TargetT is decreased by a further temperature increment at 31. By virtue of the regulation capacity maintained in this way, not only is it possible to prevent a temperature fluctuation below the maximum temperature, but it is also possible to limit the rate of fall of the actual temperature actT in a targeted manner. These are additional measures for limiting the thermal loading of the power components of the inverter 3 and thus for increasing the lifetime of these power components. In principle, if the maximum temperature is no longer reached, it is also possible to change over from regulation of the cooling power KL in accordance with FIG. 2 to control of the cooling power KL of the cooling device, as was described for example in the previous paragraph as an alternative to the regulation depicted schematically in FIG. 4. Moreover, if the actual temperature actT has reached a predefined residual temperature, the cooling power KL of the cooling device can be regulated down to zero.

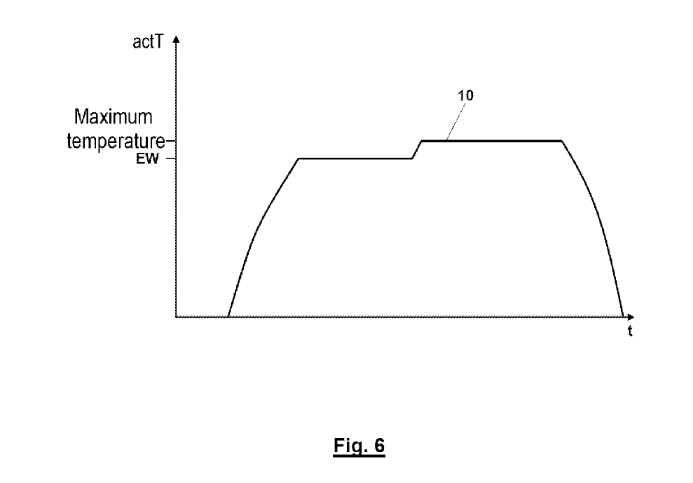

FIG. 6 schematically depicts the profile of the actual temperature 10 of the inverter 3 in accordance with FIG. 1 over time, specifically over a day, with application of the method in accordance with FIG. 2. It is indicated here that the expected value EW for the maximum temperature has to be increased once in order to reach the actual maximum temperature. In this example, therefore, the initial expected value EW is set slightly too low and the cooling device 4, taking account of the predefined maximum cooling power, is not able to adjust the actual temperature 10 to match the expected value EW set too low under the prevailing ambient conditions. Accordingly, the expected value EW is increased by an increment in order to adapt it to the maximum temperature that can be complied with over the present day.

FIG. 7 illustrates how, in the case of the method in accordance with FIG. 3, with the provisional value vW MaxT of the maximum temperature over many steps an approximation is made to the maximum temperature that can be complied with over the present day. As a result of the application of the method in accordance with FIG. 5, a stepped fall in the actual temperature 10 of the inverter 3 also occurs at the end of the day, wherein the ramps between all steps during the rise in the actual temperature 10 and during the fall thereof are flattened, i.e. have a limited gradient.

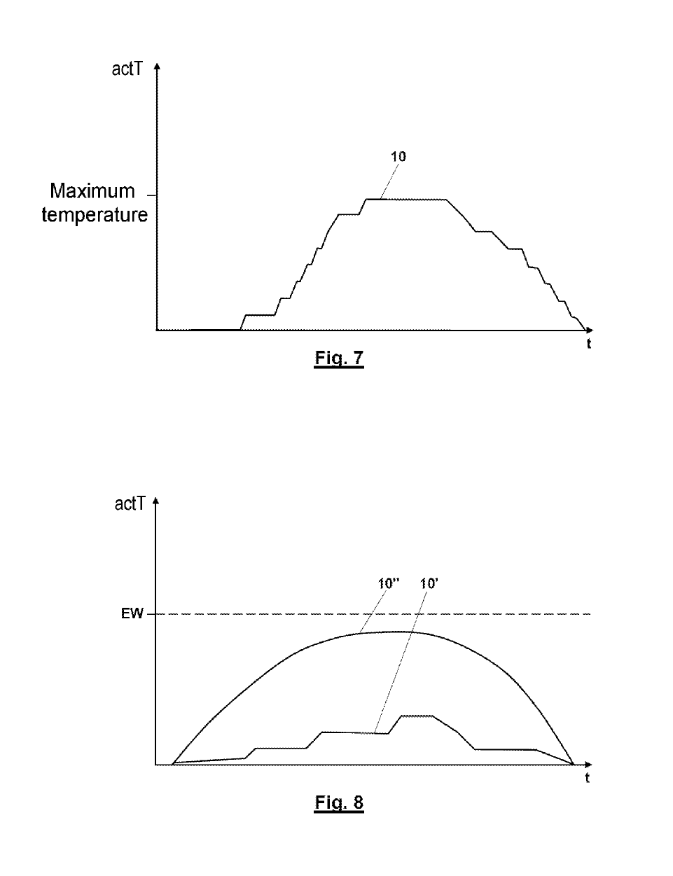

FIG. 8 illustrates the temperature profile of the actual temperature 10 for the case where an expected value is not reached at all in the method in accordance with FIG. 2 even without power of the cooling device 4, for example because it is unexpectedly cold and clouds have gathered. This is directly taken into account in the method in accordance with FIG. 3, such that a very small (stepped) temperature swing of the actual temperature 10′ occurs in said method, while in the method in accordance with FIG. 2 the actual temperature 10″ almost reaches the expected value EW set too high.

An analysis of the capacity of the method according to one embodiment of the disclosure taking account of existing data concerning the development of the waste heat of an inverter of a photovoltaic installation and the weather conditions prevailing at the same time compared with conventional temperature regulations with a fixed characteristic curve or to a fixed maximum temperature revealed that the number of large daily temperature swings and the periods with a high actual temperature of the inverter can be significantly reduced, in particular in favour of medium to small temperature swings and actual temperatures. This is even more clearly pronounced in the method in accordance with FIG. 3 than in the method in accordance with FIG. 2, although at the expense of a significantly increased average power of the cooling device 4 in the method in accordance with FIG. 3 compared with the method in accordance with FIG. 2.

1. A method for controlling a cooling device of limited power during the cooling of an apparatus which generates waste heat to a variable extent over each of a plurality of operating periods, comprising:
defining a maximum temperature of the apparatus;
detecting an actual temperature of the apparatus; and
controlling a power of the cooling device in order to limit the actual temperature to the maximum temperature,
wherein the maximum temperature is defined individually for different operating periods from among the plurality of operating periods such that a maximum power of the cooling device that occurs upon a control of the power of the cooling device during the respective operating period complies with a predefined power of the cooling device.

2. The method according to claim 1, wherein the predefined power of the cooling device is predefined by a power interval of the power consumption of the cooling device.

3. The method according to claim 1, wherein, for defining the maximum temperature, a provisional value of the maximum temperature is increased during the operating period whenever the actual temperature of the apparatus exceeds a previous provisional value of the maximum temperature at a predefined maximum power of the cooling device and/or whenever the power of the cooling device exceeds a predefined upper power limit value for a predefined period upon the control of the power of the cooling device taking account of the previous provisional value of the maximum temperature.

4. The method according to claim 3, wherein the new provisional value of the maximum temperature is defined as:
the actual temperature of the apparatus which exceeds the previous provisional value at the predefined maximum power of the cooling device, or
the previous provisional value of the maximum temperature increased by a predefined temperature increment.

5. The method according to claim 3, wherein the provisional value of the maximum temperature at the beginning of the respective operating period is defined as the current actual temperature or a value dependent on the current actual temperature or a value that is identical for each operating period.

6. The method according to claim 3, wherein the provisional value of the maximum temperature at the beginning of the respective operating period is defined as an expected value of the maximum temperature.

7. The method according to claim 6, wherein the provisional value of the maximum temperature at the beginning of the respective operating period is defined as an expected value dependent on:
the temporal situation of the operating period; and/or
weather forecasts for the operating period; and/or
an operating plan of the apparatus for the operating period.

8. The method according to claim 1, wherein the power of the cooling device is controlled such that a rise in the actual temperature until attaining the provisional value of the maximum temperature and/or the maximum temperature is limited to a maximum rate.

9. The method according to claim 1, wherein upon the control of the power of the cooling device, the power of the cooling device is set in a manner dependent on the actual temperature of the apparatus such that the power of the cooling device attains a predefined power of the cooling device if the actual temperature attains the maximum temperature.

10. The method according to claim 1, wherein upon the control of the power of the cooling device, the actual temperature of the apparatus is adjusted to match the maximum temperature as setpoint value.

11. The method according to claim 10, wherein the predefined power of the cooling device is predefined depending on the maximum temperature.

12. The method according to claim 10, wherein if the actual temperature of the apparatus falls below the maximum temperature at a predefined minimum power of the cooling device and/or if the power of the cooling device falls below a predefined lower power limit value for a predefined further period upon compliance with the maximum temperature, a changeover is made to the controlling of the power of the cooling device in which the actual temperature of the apparatus is adjusted to match a target temperature below the maximum temperature as setpoint value, or in which the cooling power is set in a manner linearly dependent on the actual temperature of the apparatus.

13. The method according to claim 10, wherein at a specific point in time during the respective operating period, a changeover is made to the controlling of the power of the cooling device in which the actual temperature of the apparatus is adjusted to match a target temperature below the maximum temperature as setpoint value, or in which the cooling power Is set in a manner linearly dependent on the actual temperature of the apparatus.

14. The method according to claim 12, wherein the target temperature is reduced proceeding from the maximum temperature if the actual temperature of the apparatus falls below the previous target temperature at a predefined minimum power of the cooling device and/or if the power of the cooling device falls below a predefined lower power limit value for a predefined further period upon compliance with the previous target temperature.

15. The method according to claim 14, wherein the new target temperature is defined as:
the actual temperature of the apparatus which falls below the previous target temperature at the predefined minimum power of the cooling device, or
the previous target temperature decreased by a predefined temperature increment.

16. The method according to claim 12, wherein a fall in the actual temperature towards the end of the respective operating period is limited to a maximum rate by the control of the power of the cooling device.

17. A cooling device for cooling an apparatus which generates power loss to a variable extent over each of a plurality of operating periods, comprising:
a temperature sensor configured to detect the actual temperature of the apparatus; and
a controller configured to control the power of the cooling device in order to limit the actual temperature to a defined maximum temperature,
wherein the controller is configured to define the maximum temperature individually for different operating periods from among the operating periods such that a maximum power of the cooling device that occurs upon the control of the power of the cooling device during the respective operating period complies with a predefined power of the cooling device.

18. The cooling device according to claim 17, wherein the controller comprises an interface configured to receive data:
concerning the temporal situation of the operating period; and/or
concerning weather forecasts for the operating period; and/or
concerning an operating plan of the apparatus for the operating period.
